(19) United States
(12) Patent Application Publication
(10) Pub. No.: US 2025/0303388 A1
(43) Pub. Date: Oct. 2, 2025

(54) Sorbent Comprising High-Hydration Lithium-Incorporated-Aluminum-Hydroxide Composition

(71) Applicant: Summit Nanotech Corporation, Calgary (CA)

(72) Inventors: Norman Wong, Calgary (CA); Hai Wang, Calgary (CA); Jeffrey Forsyth, Calgary (CA)

(21) Appl. No.: 18/863,407

(22) PCT Filed: May 5, 2023
(86) PCT No.: PCT/CA2023/050618

§ 371 Date: Nov. 6, 2024

Related U.S. Application Data
(60) Provisional application No. 63/339,170, filed on May 6, 2022.

(51) Int. Cl. B01J 20/08; B01D 15/02; B01J 20/28; B01J 20/30; C22B 3/02; C22B 3/24; C22B 26/12

(52) U.S. Cl. CPC B01J 20/08; B01D 15/02; B01J 20/28047; B01J 20/3078; B01J 20/3085; C22B 3/02; C22B 3/24; C22B 26/12

(57) ABSTRACT

The present disclosure relates to sorbents for selective metal extractions from solution, and more specifically to high-hydration lithium-incorporated-aluminum-hydroxide (H²-LIAH) compositions configured for lithium extraction. The H²-LIAH compositions of the present disclosure are differentiated from conventional LIAH compositions at least in part by their crystallization-hydrates:lithium molar ratios, which are readily detectable through analytical characterization. The H²-LIAH compositions of the present disclosure may be readily: (i) prepared by the methods of manufacture as described herein; (ii) incorporated into apparatus for recovering lithium from brine as described herein; and/or (iii) deployed in methods for lithium recovery from brine as described herein. The H²-LIAH compositions of the present disclosure were developed after discovering a surprising pH effect that induces the unexpected formation of a gel-like material during manufacturing. The gel-like material may be tailored towards H²-LIAH compositions with un-conventional properties as described herein.

### CROSS-REFERENCE TO RELATED APPLICATIONS

This application is the United States national phase of International Patent Application No. PCT/CA2023/050618 filed May 5, 2023, and claims priority to U.S. Provisional Patent Application No. 63/339,170 filed May 6, 2022, the disclosures of each of which are hereby incorporated by reference in their entireties.

### BACKGROUND

### Field

The present disclosure relates generally to sorbents for selective metal extractions from solution, and more specifically to lithium-incorporated-aluminum-hydroxide (LIAH) compositions configured for lithium extraction.

### Technical Considerations

Lithium-incorporated-aluminum-hydroxide (LIAH) compositions are a promising class of inorganic sorbents for direct lithium extraction (DLE). DLE is an alternative to conventional lithium recovery approaches such as open pit mining and large basin evaporation-both of which may lead to land destruction, potential contamination, and/or high water consumption. DLE is likely to attenuate these impacts, as it utilizes a selective sorbent to extract lithium from brine.

LIAH compositions may be effective sorbents for extracting lithium from a variety of brine types, and their preparation and/or use tends to require less chemical input than alternative inorganic sorbent categories. Unfortunately, however, conventional methods for preparing LIAH sorbent compositions are limited by synthetic constraints with little room for tailoring the final compositions towards desirable properties, such as high hardness, high selectivity for lithium, high lithium uptake capacity, narrow particle size distribution, etc. These characteristics are likely central to the widespread application of DLE.

Gibbsite impregnation is a conventional approach to preparing LIAH compositions. This process may be complicated by long preparation times, for example due to slow gibbsite dissolution. Moreover, sorbents produced by Gibbsite impregnation tend to have low lithium uptake capacities.

In situ precipitation of LIAH compositions has been explored as a manufacturing process for lithium sorbents. However, reported processes tend to yield products with broad particle size distributions, low crystallinity, and/or low lithium uptake capacities.

Hydrothermal processes have also been explored for the preparation of LIAH compositions. Unfortunately, the sorbents they yield suffer from numerous limitations, and the processes themselves can introduce undesirable costs and/or complexities having regard to their high pressure and/or high temperature parameters.

There is an unmet need for novel LIAH compositions that are suitable for extracting lithium from brine. There is also an unmet need for: (i) methods of manufacturing that enable tailoring novel LIAH compositions towards desirable properties; (ii) apparatus for recovering lithium from brines that utilize novel LIAH compositions; and (iii) methods of recovering lithium from brine that use novel LIAH compositions.

### SUMMARY

The present disclosure reports sorbents comprising high-hydration lithium-incorporated-aluminum-hydroxide (H²-LIAH) compositions and methods of manufacturing the same. The H²-LIAH compositions of the present disclosure were developed after extensive research into alternative methods for lithium sorbent preparation uncovered a surprising pH effect during manufacturing. As set out in the present disclosure, the pH effect can be utilized to induce the unexpected formation of a gel-like material, which can then be processed into LIAH compositions with desirable properties. Analytical characterizations indicate that the gel formation is exothermic and that the resultant materials feature lattice structures that extensively incorporate crystallization-hydrates. Without being bound to any particular theory, crystallization-hydrate incorporation within the H²-LIAH compositions of the present disclosure may impact d-spacing and/or lattice formation during crystallization, and this may explain why the gel-like materials formed during manufacturing are amenable to tailoring towards desirable properties (e.g. high lithium capacity, high hardness, high physical durability under operating conditions, high chemical durability under operating conditions, large average particle size, and/or narrow particle size distribution) by selecting and executing appropriate curing protocols (e.g. aging, rinsing, drying, and sieving).

In the context of the present disclosure, the terms “crystallization-hydrate” and “crystallization-hydrates” are used interchangeably and refer to matter with an endothermic transition that is detectable between about 270° C. and about 350° C. by differential scanning calorimetry (DSC). Accordingly, the presence, absence, and/or degree of incorporation of crystallization-hydrates in a material may be readily determined by those skilled in the art. The present disclosure provides teachings on determining molar ratios of crystallization-hydrates:lithium from DSC data in combination with complementary characterizations including inductively-coupled plasma optical emission spectrometry (ICP-OES), thermogravimetric analysis (TGA), and/or X-ray diffraction (XRD). The H²-LIAH compositions of the present disclosure are differentiated from conventional LIAH compositions at least in part by their crystallization-hydrate:lithium molar ratios as delineated in the appended claims. The H²-LIAH compositions of the present disclosure may be readily: (i) prepared by the methods of manufacture set out in the present disclosure; (ii) incorporated into apparatus for recovering lithium from brine; and/or (iii) deployed in methods for lithium recovery from brine.

An aspect of the present disclosure relates to a sorbent for recovering lithium from a lithium containing solution, the sorbent comprising a H²-LIAH composition having a crystallization-hydrate:lithium molar ratio of at least about 2.1:1.0.

In an embodiment of the present disclosure, the crystallization-hydrate:lithium molar ratio of the H²-LIAH composition is between about 2.1:1.0 and about 4.3:1.0.

In an embodiment of the present disclosure, the crystallization-hydrate:lithium molar ratio of the H²-LIAH composition is between about 2.1:1.0 and about 2.9:1.0.

In an embodiment of the present disclosure, the crystallization-hydrate:lithium molar ratio of the H²-LIAH composition is between about 2.9:1.0 and about 4.0:1.0.

In an embodiment of the present disclosure, the crystallization-hydrate:lithium molar ratio of the H²-LIAH composition is determined from DSC, ICP-OES, TGA, or a combination thereof.

In an embodiment of the present disclosure, the H²-LIAH composition has an XRD pattern having 2θ reflectance peaks at approximately 11.5° 2θ, 23.1° 2θ, 35.0° 2θ, 35.7° 2θ, or a combination thereof.

In an embodiment of the present disclosure, the H²-LIAH composition has an XRD pattern having an absence of 2θ reflectance peaks at 18.2° 2θ.

In an embodiment of the present disclosure, the H²-LIAH composition has an aluminum:lithium molar ratio of at least about 1.9:1.0.

In an embodiment of the present disclosure, the H²-LIAH composition has an aluminum:lithium molar ratio of between about 2.0:1.0 and about 3.0:1.0.

In an embodiment of the present disclosure, the H²-LIAH composition has an aluminum:lithium molar ratio of between about 2.4:1.0 and about 2.6:1.0.

In an embodiment of the present disclosure, the H²-LIAH composition is as described in Formula 1:

LiₐX·mAl(OH)₃·nH₂O_{cr} Formula 1
wherein:
   a is about 1;
   X is a mono-valent anion;
   m is between about 1.9 and about 3.0;
   n is between about 2.4 and about 4.3; and
   H₂O_{cr} specifies crystallization-hydrate.

In an embodiment of the present disclosure, the H²-LIAH composition is a lithium-aluminum-layered-double-hydroxide composition.

In an embodiment of the present disclosure, the sorbent further comprises a binding agent, an encapsulating agent, or a combination thereof.

In an embodiment of the present disclosure, the H²-LIAH composition has a lithium-uptake capacity of at least about 8.0 mg/mL.

In an embodiment of the present disclosure, the lithium-uptake capacity of the H²-LIAH composition is at least about 9.0 mg/mL.

In an embodiment of the present disclosure, the lithium-uptake capacity of the H²-LIAH composition is between about 9.5 mg/ml and about 12.0 mg/mL.

In an embodiment of the present disclosure, the H²-LIAH composition is processable to provide a particle size distribution in which at least about 40% of particles are between about 500 μm, and about 1,000 μm.

In an embodiment of the present disclosure, the H²-LIAH composition is processable to provide a particle size distribution in which at least about 50% of particles are between about 500 μm, and about 1,000 μm.

In an embodiment of the present disclosure, the H²-LIAH composition is processable to provide a particle size distribution in which at least about 55% of particles are between about 500 μm, and about 1,000 μm.

In an embodiment of the present disclosure, suspending the H²-LIAH composition in deionized water provides a solution having a pH of between about 7.0 and about 6.2.

In an embodiment of the present disclosure, suspending the H²-LIAH composition in deionized water provides a turbidity value of less than 10 NTU.

In an embodiment of the present disclosure, suspending the H²-LIAH composition in deionized water provides a turbidity value of less than 5 NTU.

In an embodiment of the present disclosure, suspending the H²-LIAH composition in deionized water provides a turbidity value of between about 2.5 NTU and about 5 NTU.

In an embodiment of the present disclosure, the H²-LIAH composition has a Mohs hardness of at least about 5.0.

In an embodiment of the present disclosure, the Mohs hardness of the H²-LIAH composition is at least about 6.0.

In an embodiment of the present disclosure, the Mohs hardness of the H²-LIAH composition is at least about 7.0.

In an embodiment of the present disclosure, the H²-LIAH composition is robust with respect to physical degradation for at least about 500 column cycles.

In an embodiment of the present disclosure, the H²-LIAH composition is robust with respect to physical degradation for at least about 5,000 column cycles.

An aspect of the present disclosure relates to a method of manufacturing a H²-LIAH composition, the method comprising:
(i) contacting an initial aliquot of a hydroxide solution with an initial aliquot of a solution comprising a lithium halide and an aluminum halide to form a reaction mixture in which the hydroxide solution is in excess, and the pH of the reaction mixture is at least about 9.0;
(ii) adding a further aliquot of a solution comprising a lithium halide and an aluminum halide to the reaction mixture, and reducing the pH of the reaction mixture to less than about 4.0;
(iii) allowing the reaction mixture to form a gel-like material; and
(iv) adding an additional aliquot of the hydroxide solution to the reaction mixture to increase the pH of the reaction mixture to between about 6.0 and about 7.5.

In an embodiment of the present disclosure, in step (i), the initial aliquot of the hydroxide solution is added to the initial aliquot of the solution comprising the lithium halide and the aluminum halide.

In an embodiment of the present disclosure, in step (i), the pH of the reaction mixture is between about 9.0 and about 11.0.

In an embodiment of the present disclosure, in step (i), the pH of the reaction mixture is about 10.0.

In an embodiment of the present disclosure, in step (ii), the pH of the reaction mixture is between about 2.5 and about 4.0.

In an embodiment of the present disclosure, in step (ii), the pH of the reaction mixture is about 3.0.

In an embodiment of the present disclosure, in step (i), the initial aliquot of the solution comprising the lithium halide and the aluminum halide is added to the initial aliquot of the hydroxide solution.

In an embodiment of the present disclosure, the initial aliquot of the solution comprising the lithium halide and the aluminum halide and the further aliquot of the solution comprising the lithium halide and the aluminum halide are derived from the same stock solution.

In an embodiment of the present disclosure, the initial aliquot of the hydroxide solution and the further aliquot of the hydroxide solution are derived from the same stock solution.

In an embodiment of the present disclosure, the solution comprising the lithium halide and the aluminum halide has a lithium:aluminum molar ratio of between about 1.0:2.0 and about 1.0:3.0.

In an embodiment of the present disclosure, the hydroxide solution has a concentration of between about 6.5 M and about 8.0 M.

In an embodiment of the present disclosure, the lithium halide is lithium fluoride, lithium chloride, lithium bromide, lithium iodide, or a combination thereof.

In an embodiment of the present disclosure, the lithium halide is lithium chloride.

In an embodiment of the present disclosure, the aluminum halide is aluminum trifluoride, aluminum trichloride, aluminum tribromide, aluminum triiodide, or a combination thereof.

In an embodiment of the present disclosure, the aluminum halide is aluminum trichloride.

In an embodiment of the present disclosure, the hydroxide solution is a sodium hydroxide solution, a potassium hydroxide solution, a calcium hydroxide solution, a magnesium hydroxide solution, or a combination thereof.

In an embodiment of the present disclosure, the hydroxide solution is a sodium hydroxide solution.

In an embodiment of the present disclosure, the rate of addition of the hydroxide solution in step (i) and/or step (iv) is between about 9.5 mL/min and about 10.5 mL/min.

In an embodiment of the present disclosure, in step (iii), step (iv), or a combination thereof, the reaction mixture is agitated to modulate the viscosity of the gel-like material.

In an embodiment of the present disclosure, in step (iii), step (iv), or a combination thereof, the temperature of the reaction mixture is controlled to modulate the viscosity of the gel-like material.

In an embodiment of the present disclosure, in step (iii), step (iv), or a combination thereof, the pressure of the reaction mixture is controlled to modulate the viscosity of the gel-like material.

In an embodiment of the present disclosure, in step (iii), step (iv), or a combination thereof, the reaction time is controlled to modulate the viscosity of the gel-like material.

In an embodiment of the present disclosure, in step (ii), step (iv), or a combination thereof, the rate of addition is controlled to modulate the viscosity of the gel-like material.

In an embodiment of the present disclosure, the method further comprises: (v) curing the gel-like material into the H²-LIAH composition.

In an embodiment of the present disclosure, step (v) comprises drying at a temperature between about 85° C. and about 105° C.

In an embodiment of the present disclosure, step (v) comprises drying for between about 24 h and about 75 h.

In an embodiment of the present disclosure, step (v) comprises drying at a pressure between about 76 mmHg and 760 mmHg.

In an embodiment of the present disclosure, step (v) comprises aging, rinsing, drying, sieving, or a combination thereof.

An aspect of the present disclosure relates to a sorbent manufactured by a method as defined herein.

An aspect of the present disclosure relates to an apparatus for recovering lithium from a lithium containing solution, the apparatus comprising:
a container having an inlet, an outlet, and a contiguous flow path therebetween; and
a sorbent in the container, the sorbent comprising a H²-LIAH composition having a crystallization-hydrate:lithium molar ratio of between about 2.1:1.0 and about 4.3:1.0.

An aspect of the present disclosure relates to an apparatus for recovering lithium from a lithium containing solution, the apparatus comprising:
a container having an inlet, an outlet, and a flow path therebetween; and
a sorbent in the container, wherein the sorbent is as defined herein.

An aspect of the present disclosure relates to a method for recovering lithium from a lithium containing solution, the method comprising:
contacting the lithium containing solution with a sorbent composition to extract lithium from the lithium containing solution; and
eluting lithium from the sorbent composition to form a lithium-eluate solution,
wherein the sorbent composition comprises a H²-LIAH composition having a crystallization-hydrate:lithium molar ratio of between about 2.1:1.0 and about 4.3:1.0.

An aspect of the present disclosure relates to a method for recovering lithium from a lithium containing solution, the method comprising:
contacting the lithium containing solution with a sorbent composition to extract lithium from the lithium containing solution; and
eluting lithium from the sorbent composition to form a lithium eluate solution,
wherein the sorbent composition comprises a H²-LIAH composition as defined herein.

A method for recovering lithium from a lithium containing solution, the method comprising:
contacting the lithium-containing solution with a sorbent comprising a H²-LIAH composition as defined herein to extract lithium from the lithium-containing solution; and
eluting lithium from the sorbent to form a lithium eluate solution.

### BRIEF DESCRIPTION OF THE DRAWINGS

The terms Fig., Figs., Figure, and Figures are used interchangeably in the specification to refer to the corresponding figures in the drawings.

In the drawings and description provided herein, similar reference numerals indicate similar components. For sake of simplicity and clarity, not all drawings contain references to all the components and features, and references to some components and features may be found in only one drawing. Components and features of the present disclosure which are illustrated in other drawings can be readily inferred therefrom.

FIG. 1 shows a differential scanning calorimetry (DSC) graph 100 depicting relative enthalpic variation as a function of temperature for a conventional lithium aluminum hydroxide (LIAH) composition and a high-hydration lithium-incorporated-aluminum-hydroxide (H²-LIAH) composition of the present disclosure.

FIG. 2 shows a normalized thermogravimetric analysis (TGA) plot 200 depicting sample weight changes (expressed as a relative percent) as a function of temperature. A series of H²-LIAH compositions of the present disclosure are shown, and their major decomposition events are indicated.

FIG. 3 shows an X-ray diffraction (XRD) diffractogram 300 depicting the characteristic crystalline pattern of two H²-LIAH compositions of the present disclosure overlayed with that of conventional LIAH composition prepared via a Gibbsite impregnation method. The primary characteristic peaks of the H²-LIAH compositions of the present disclosure and the conventional LIAH composition are indicated.

FIG. 4 shows a Fourier transform infrared (FTIR) spectra overlay 400 of a H²-LIAH composition of the present disclosure before 401 and after 402 high temperature drying. Primary aluminum-oxygen bonding absorbance bands are indicated.

FIG. 5 shows a microscope image of a H²-LIAH composition of the present disclosure and a standard decimal ruler (i.e., each graduation representing 1 mm) for reference with respect to particle size.

FIG. 6 shows an absorption curve 600 depicting relative changes in lithium concentration as a function of time for a brine and a H²-LIAH sorbent material of the present disclosure during a lithium extraction cycle.

FIG. 7 shows a curve depicting lithium concentration as a function of time for a H²-LIAH sorbent material of the present disclosure across multiple lithium extraction cycles.

FIG. 8 shows an apparatus 800 for recovering lithium from a lithium containing solution in accordance with an embodiment of the present disclosure. FIG. 8 also shows a method 850 for recovering lithium from a lithium containing solution in accordance with an embodiment of the present disclosure.

### DETAILED DESCRIPTION

The following detailed description and examples are illustrative and should not be interpreted as further limiting the scope of the invention. On the contrary, it is intended to cover all alternatives, modifications and equivalents that can be included as described by the present description. Objects, advantages and other features of the compositions, methods and apparatus will be more apparent and better understood by those skilled in the art upon reading the following non-restrictive description and references made to the accompanying drawings.

The majority of conventional methods for preparing LIAH compositions by in situ precipitation use Al(OH)₃ as a starting material instead of AlCl₃, as the latter is hazardous and may be difficult to handle safely. Conventional methods that do use AlCl₃ as a starting material tend to employ a single addition step, where: (i) slow and controlled addition of a LiCl/AlCl₃ solution to a basic (e.g. hydroxide) solution brings pH downward to between 6.5 and 7.0, without dropping substantially below this range; or (ii) no pH control is employed during the addition of a stoichiometric amount of a LiCl/AlCl₃ solution to a basic (e.g., hydroxide) solution, such that the final pH of the mixture is often greater than 7, most likely between 8.5 and 10.

In contrast, the methods of manufacturing of the present disclosure utilize a pH-inversion protocol that involves multiple steps. The pH-inversion protocol of the present disclosure differs from conventional approaches in that the quantities and order of addition are controlled and/or selected such that the pH of the reaction mixture swings past the ranges noted above-down to an acidic minima, such as about 3.0, before being slowly returned to between about 6.5 and about 7.0. In other words, the pH-inversion protocol of the present disclosure swings past neutral and then approaches it from the acidic side of the pH scale. The pH-inversion protocol of the present disclosure induces formation of a gel-like material at or near the pH minima. The gel formation is readily detectable as a change in solution viscosity, and it was determined that mixing rate, reagent concentration, reagent addition order (and/or other reaction parameters) could be varied to modulate the strength of the gel. The properties of the H²-LIAH compositions of the present disclosure may correlate with: (i) the strength of the gel produced in this manner; and (ii) the particular curing protocols employed to produce the H²-LIAH composition in final form. Those skilled in the art, having benefited from the teachings of the present disclosure will appreciate that control and optimization of batch scaleup parameters may impact the strength of the gel (e.g. mixing volume relative to reaction type, sizing of mixing apparatus, and balance of reaction dilution relative to constraints of drying time) and that particular curing protocols (e.g. appropriate homogenization and mixing during the course of aging, rinsing to remove salt impurities, removal of moisture via drying, and/or sieving for select particle sizes) may be employed to produce a H²-LIAH composition that is tailored towards one or more desirable qualities as described herein.

As noted above, analytical characterizations indicate that the H²-LIAH compositions of the present disclosure feature lattice structures that incorporate crystallization-hydrates extensively. In the context of the present disclosure, the terms “crystallization-hydrate” and “crystallization-hydrates” are used interchangeably and refer to matter with a detectable endothermic transition between about 270° C. and about 350° C. by differential scanning calorimetry (DSC). Crystallization-hydrate may include water incorporated within or released from a crystal lattice, partial decomposition products of a crystal lattice, and/or complete decomposition products of a crystal lattice. In the context of the present disclosure, crystallization-hydrates are differentiated from “surface-hydrates”, as this term refers to matter with a detectable endothermic transition between about 30° C. and about 130° C. by DSC.

Without being bound to any particular theory, crystallization-hydrate incorporation within the LIAH compositions of the present disclosure may impact d-spacing and/or lattice formation during crystallization. This process may explain why the gel-like material that is formed during manufacturing may be amenable to tailoring towards desirable properties (e.g. high lithium capacity, high lithium selectivity, high hardness, high physical durability under operating conditions, high chemical durability under operating conditions, large average particle size, and/or narrow particle size distribution) by selecting and executing appropriate curing protocols (e.g. aging, rinsing, drying and sieving).

These and other teachings, objects, features, examples, ranges, thresholds, and advantages of the present disclosure will be apparent to those skilled in the art having regard to the following description of particular embodiments of the H²-LIAH compositions of the present disclosure with reference to the appended drawings-including their incorporation into a sorbent for recovering lithium from brine, methods for their manufacture, their incorporation into apparatus for recovering lithium from brine, and their use in methods for recovering lithium from brine-without limitation to the scope of the appended claims.

### Sorbents Comprising H²-LIAH Compositions

H²-LIAH compositions of the present disclosure were analyzed using a suite of analytical techniques to confirm various properties as set out below. Specific results are discussed with reference to archetypal examples and with teachings to enable those skilled in the art to determine, for example, the crystallization-hydrate:lithium ratio of a LIAH composition, and more generally to detect features that differentiate the H²-LIAH compositions of the present disclosure from conventional LIAH compositions. Analysis of the H²-LIAH compositions of the present disclosure need not be limited to the analytical techniques discussed below, and those skilled in the art will appreciate that other characterization techniques may supplement, support, or replace one or more of the foregoing analyses without departing from the scope of the present disclosure.

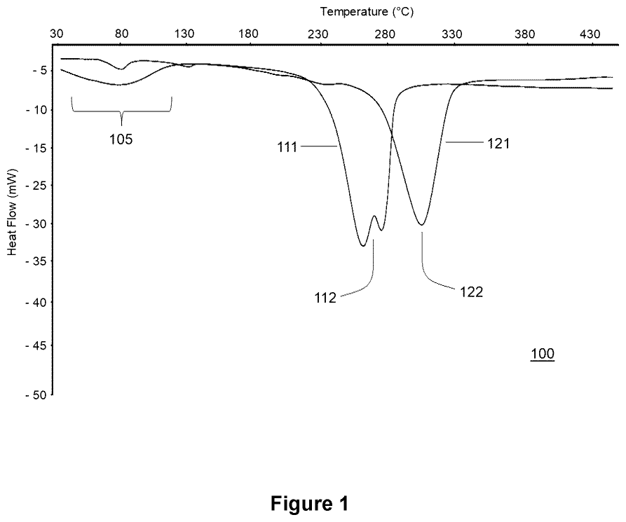

The endothermic transitions of a H²-LIAH composition may be determined by DSC. Those skilled in the art will appreciate the particulars of routine DSC characterizations as used in the present disclosure. FIG. 1 shows a DSC graph 100 depicting relative enthalpic variation as a function of temperature for a conventional LIAH composition 111, and a H²-LIAH composition of the present disclosure 121. Representative of the H²-LIAH compositions of the present disclosure, a characteristic enthalpic event 122 is observed with a distinctive and characteristic onset temperature, about 270° C., as compared to that of the conventional LIAH composition 112, which is observed with an onset temperature of about 200° C. In FIG. 1, Surface-hydrate loss 105 may be noted by wide, low intensity enthalpic events centered at about 80° C. for both materials.

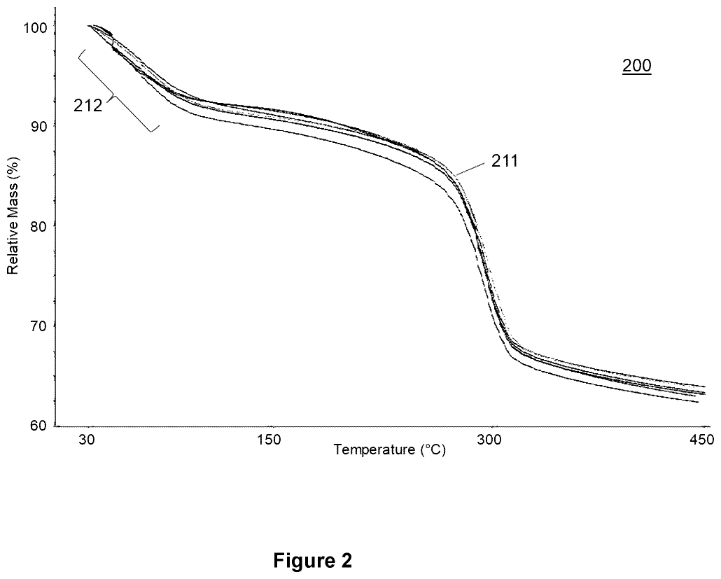

The decomposition pattern of a H²-LIAH composition may be determined by TGA. Those skilled in the art will appreciate the particulars of routine TGA characterizations as used in the context of the present disclosure. FIG. 2 shows a normalized TGA plot 200 depicting sample weight changes (expressed as a relative percent) as a function of temperature for a series of H²LIAH compositions prepared by various methods of manufacturing in accordance with the present disclosure. Across the series, a major decomposition event 211 may be seen at an onset beginning at about 270° C. and offset ending at about 310° C. Complementary to the DSC characterization in FIG. 1. Surface-hydrate loss is also detectable in FIG. 2 as indicated by reference number 212. The series presented in FIG. 2 support the general reproducibility of thermal decomposition parameters for H²-LIAH compositions prepared by various methods of manufacturing of the present disclosure.

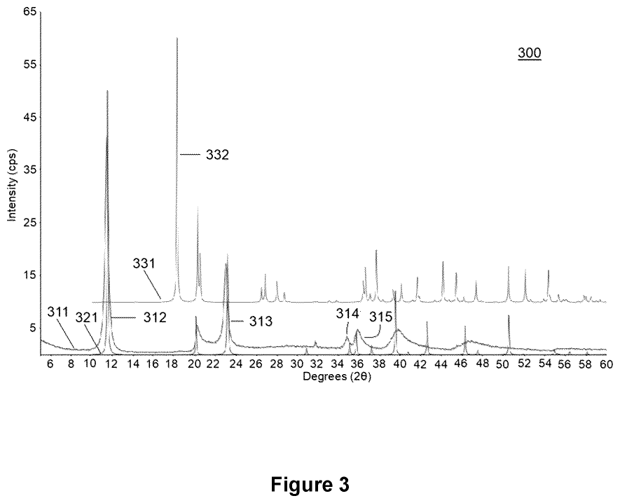

The crystal diffraction pattern of a H²-LIAH composition may be determined by XRD. Those skilled in the art will appreciate the particulars of routine XRD characterizations as used in the context of the present disclosure. FIG. 3 shows an XRD diffractogram 300 depicting the characteristic crystalline pattern of two H²-LIAH compositions of the present disclosure (311 and 321) overlayed with that of a conventional LIAH composition manufactured via a Gibbsite impregnation method 331. The primary characteristic peak of the H²-LIAH compositions of the present disclosure is at about 11.5° 2θ (312). Additional characteristic peaks of the H²-LIAH compositions of the present disclosure 313, 314, and 315, are at about 23.1° 2θ, about 35.0° 2θ, and about 35.7° 2θ, respectively. The primary characteristic peak of the conventional LIAH composition is at about 18.2° 2θ (332). This peak is conspicuously absent in the H²-LIAH compositions of the present disclosure. In an embodiment of the present disclosure, the H²-LIAH compositions have an XRD pattern substantially as shown in FIGS. 3 (311 and 321).

The molecular formula outlined by Formula 1 may be determined using manufacturing information and subsequent H²-LIAH characterization data described in the present disclosure. Following the embodiments provided herein discussing an archetypal H²-LIAH composition of the present example, specific the use of lithium chloride identifies integer “a” is 1 and mono-valent anion “X” is chloride. Thus, the partial molecular formula may initially be determined to be: LiCl·mAl(OH)₃·nH₂O_{cr}.

With respect to the archetypal H²-LIAH composition of the present disclosure, elemental composition data for H²-LIAH compositions of the present disclosure may be determined by ICP-OES. Those skilled in the art will appreciate the particulars of routine ICP-OES characterizations as used in the context of the present disclosure. Elemental composition data for an archetypal H²-LIAH composition of the present disclosure is summarized in Table 1.

TABLE 1
H²-LIAH elemental composition as analyzed by ICP-OES.

| | | | Mol. Conc. | ppm | Ratio |
|---|---|---|---|---|---|
| Element | MW | Conc. (mg/L) | (mmol/L) | (mg/kg) | vs. Li |
| Li | 6.94 | 120.06 | 17.30 | 22809.07 | 1 |
| Na | 22.99 | 458.07 | 19.92 | 87027.33 | N/A |
| K | 30.99 | 1.43 | 0.04 | 272.18 | N/A |
| Mg | 24.305 | 0.49 | 0.02 | 93.62 | N/A |
| Ca | 40.078 | 1.37 | 0.03 | 259.82 | N/A |
| Sr | 10.811 | <0.00 | <0.00 | 0.68 | N/A |
| Ba | 137.327 | <0.00 | <0.00 | 0.11 | N/A |
| Al | 26.98 | 1070.26 | 39.67 | 203335.73 | 2.29 |

With respect to the archetypal H²-LIAH composition of the present disclosure, the ratio of aluminum to lithium, normalizing the molar concentration of lithium to 1, is thus determined to be 2.32:1. Having normalized the ratio relative to lithium, the aluminum ratio may be input into Formula 1 as integer “m”, and the partial molecular formula may be further described: LiCl·2.32Al(OH)₃·nH₂O_{cr}.

In the context of the present disclosure, the crystallization-hydrate:lithium ratio of a LIAH composition may be determined as follows.

TGA data can be used to differentiate specific heating zones within which surface-hydrates and crystallization-hydrates are individually lost during the analysis of a hydrate containing LIAH material. Table 2 summarizes TGA data at two specific timepoints for an archetypal H²-LIAH composition of the present disclosure, which describe a temperature range across which crystallization-hydrates may be observed.

TABLE 2
H²-LIAH relative mass reading during heating

| Relative TGA Mass | Relative TGA Mass |
|---|---|
| at 120° C. (%) | at 350° C. (%) |
| 92.102 | 71.715 |

In the context of the present disclosure, relative TGA mass values may be used to determine relative mass loss, in percent, specific to crystallization-hydrates, as outlined in Formula 2:

$$Rel . {Loss}_{c r y} = Rel . {Mass}_{12 {0}^{∘} C .} - Rel . {Mass}_{35 {0}^{∘} C .} \qquad Formula 2$$

wherein:
   Rel. Mass_{120° C.} is the TGA measurement of relative mass at 120° C.; and
   Rel. Mass_{350° C.} is the TGA measurement of relative mass at 350° C.

With respect to the archetypal H²-LIAH composition of the present disclosure and its TGA data of Table 2, the relative mass loss of crystallization-hydrates was determined to be 20.387%.

In the context of the present disclosure, crystallization-hydrate:lithium molar ratios may be calculated from TGA data and ICP-OES data by mass balance using Formula 3. The ICP-OES data is first assessed to provide the aluminum:lithium molar ratio, which is then used in Formula 3. Alternatively, if desired, similar ratios may be determined using mass values as derived from these data. The archetypal H²-LIAH composition of the present disclosure was determined to have an aluminum:lithium ratio of about 2.3:1.0 based on the data in Table 1.

$$R , {m}_{H 20 , cry} = \frac{\begin{matrix}\frac{( R , {l}_{L i C l} \times M {W}_{L i C l} ) + ( R , {n}_{AlOH 3} \times M {W}_{AlOH 3} )}{M {W}_{H 2 O}} \times \\ Rel . {Loss}_{cry}\end{matrix}}{100} \qquad Formula 3$$

wherein:
   R,l is the molar ratio of lithium, which is normalized to 1;
   R,n is the molar ratio of aluminum trihydroxide relative to lithium;
   MWₓ is the molecular weight of the species in question;
      MW_{Licl}=42.40 g/mol;
      MW_{AlOH3}=78.00 g/mol;
      MW_{H2O}=18.02 g/mol; and
   Rel.Loss_{cry} is the relative percent mass loss of crystallization-hydrate.

With respect to the archetypal H²-LIAH composition of the present disclosure and its TGA data, the relative mass loss of crystallization-hydrates was determined to be 2.5. Accordingly, the specific molecular formula for the archetypal H²-LIAH composition of the present example, having identified the final integer “n”, may be expressed fully. Formula 1 is thus determined as:

LiCl·2.3 Al(OH)₃·2.5 H²O_{cry}

H²-LIAH material compositions of the present disclosure were evaluated with a suite of analytical techniques to determine the impact of the loss crystallization-hydrates. Representative experimental results are outlined below.

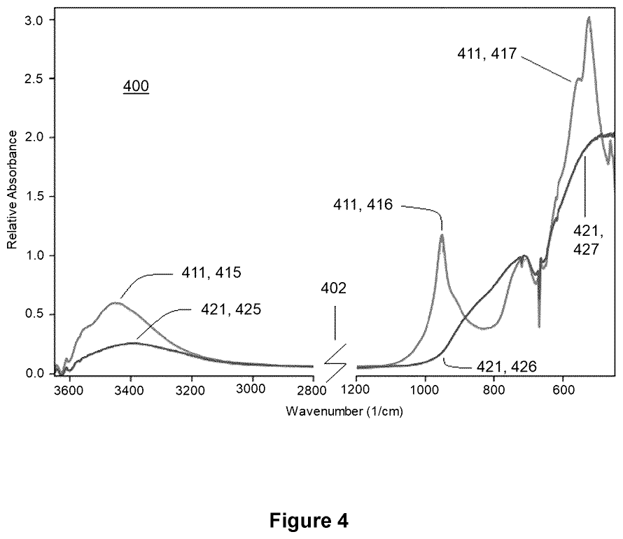

FIG. 4 shows a Fourier transform infrared (FTIR) spectra overlay 400 of a H²-LIAH composition of the present disclosure before 411 and after 421 high temperature drying. Individual FTIR bands have been identified for the purpose of this discussion, and are assigned to their respective material. For brevity, the x-axis is truncated by a caesura 405. General —OH bond stretch absorbances may be noted for both materials with a strong relative absorbance shown for the H²-LIAH composition before high temperature drying 415 and a reduced absorbance for the H²-LIAH composition after high temperature drying 425. Absorbance bands indicative of aluminum bonding are identified for the H²-LIAH composition before high temperature drying with reference numerals 416 and 417. After high temperature drying, the H²-LIAH composition shows distinct loss of the Al—O-stretch band 426, and a reduced Al—OH bend band 427. Without being bound to any particular theory, the changes observed for the Al—O-bonding bands suggest a significant loss of crystallinity as a result of high temperature drying. The loss of crystallinity associated with high temperature drying may also be observed in DSC data set out above. The endotherm 301 observed in FIG. 1 lacks indications of a subsequent recrystallization event, as observed in peak shape and graph trends, such as the symmetrical, Gaussian shape and the lack of sharp slope resultant of supercooling recrystallization events.

Hydroxide ion retention was determined for a H²-LIAH composition of the present disclosure and a conventional LIAH composition. In each case, a dried sample was suspended in deionized water, and the pH of the resultant solution was measured using a calibrated pH meter. The results are set out in Table 3. The H²-LIAH composition of the present disclosure was found to have a lower hydroxide retention than the conventional LIAH composition, which may provide for improved performance in a sorbent for lithium recovery—particularly in applications involving brines having non-trivial concentrations of divalent ions, which tend to precipitate in the presence of hydroxide ions.

TABLE 3
Excess hydroxide retention of a H²-LIAH composition
and a conventional LIAH composition

| Composition | pH of Solution |
|---|---|
| H²-LIAH composition | 6.28 |
| Conventional LIAH composition | 6.20 |

Structural and chemical robustness were evaluated via turbidity measurements for a H²-LIAH composition of the present disclosure and a conventional LIAH composition. The turbidity results for the H²-LIAH composition of the present disclosure and the conventional LIAH composition are set out in Table 4. The results indicate that structural and chemical robustness of the H²-LIAH composition of the present disclosure were enhanced relative to the conventional LIAH, which may correlate with enhanced chemical durability as a sorbent for lithium recovery from brine.

TABLE 4
Turbidity measures of solutions decanted from a H²-LIAH
composition and a conventional LIAH composition.

| Composition | Turbidity of Solution (NTU) | Average Turbidity (NTU) |
|---|---|---|
| H²-LIAH composition | 2.24, 2.47, 2.37, 2.51 | 2.40 |
| Standard LIAH composition | 933, 876, 915, 873 | 899 |

Hardness was determined for a H²-LIAH composition of the present disclosure and a conventional LIAH composition using a scratch test and Mohs scale. The hardness results for the sample associated with the H²-LIAH composition and the conventional LIAH composition are set out in Table 5. The results indicate that hardness of the H²-LIAH composition of the present disclosure was enhanced relative to the conventional LIAH composition, which may correlate with enhanced physical durability as a sorbent for lithium recovery from brine.

TABLE 5
Scratch test results for a H²-LIAH composition
and a conventional LIAH composition.

| Composition | Observations | Approximate Hardness |
|---|---|---|
| H²-LIAH composition | Scratched easily with glass/steel | 6 |
| Standard LIAH composition | Scratched easily with copper wire | 3 |

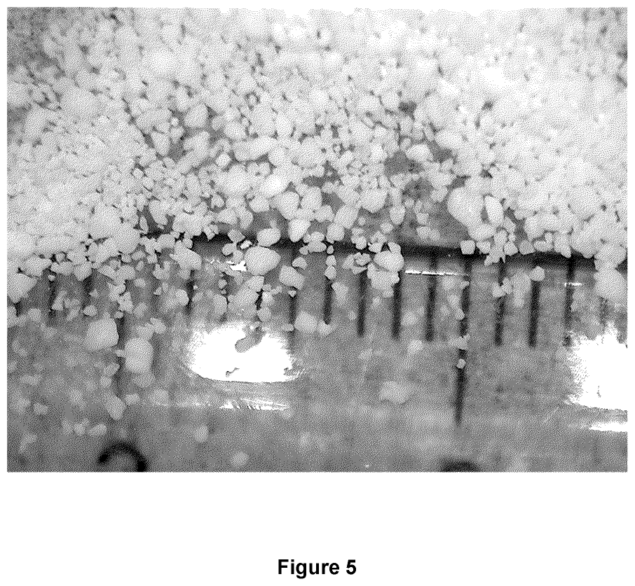

FIG. 5 shows a microscope image of a H²-LIAH composition of the present disclosure and a standard decimal ruler (i.e., each graduation representing 1 mm) for reference with respect to particle size. the LIAH composition is processable to provide a particle size distribution in which at least: (i) about 40% of particles are between about 500 μm, and about 1,000 μm; (ii) about 50% of particles are between about 500 μm, and about 1,000 μm; or (iii) at least about 55% of particles are between about 500 μm, and about 1,000 μm.

Lithium uptake capacity was determined for a H²-LIAH composition of the present disclosure and a conventional LIAH composition using a bench scale column apparatus.

The apparatus featured lab stand and a jacketed glass column with an inner diameter of about 3.2 cm, a height of about 20 cm and a frit to minimize loss of particles. Heating for the column was provided by an external circulating water bath with a set operating temperature. In each case, a preweighed mass of test composition (between about 50 g and about 70 g) at a predetermined particle size range was transferred to the column. The packed sorbent height was determined after pumping water or eluent (200 ppm Li solution) through the column using the operating flow path (top down). To prepare the test composition for adsorption, an initial elution was performed using the eluent to a total of 10 bed volumes to remove entrained lithium. Following this, the adsorption and elution stages were performed at elevated temperatures between 40° C. to 80° C. using a prepared synthetic feed brine and eluent respectively. The synthetic brine included the species set out in Table 6 at the noted concentrations as determined via ICP-OES or inductively coupled plasma mass spectrometry (ICP-MS).

TABLE 6
Composition of a brine feed used in evaluating H2-LIAH
compositions in accordance with the present disclosure

| Ion | Concentration |
|---|---|
| Lithium | 600 to 800 ppm |
| Sodium | 96,000 to 100,000 ppm |
| Potassium | 20,000 to 25,000 ppm |
| Calcium | 400 to 500 ppm |
| Magnesium | 4,000 to 5,000 ppm |
| Boron | 500 ppm |

Processing volumes for the adsorption stage were calculated using a target maximum lithium capacity of 10 mg/g based on the amount of sorbent weighed and packed into the column—this correlated to between 5 to 10 bed volumes. Flow rates were adjusted such that the flux rate of fluid through the sorbent were between 300 to 400 L/m₂/hour. To determine the performance of the test compositions during the adsorption stage, samples were obtained from the outlet (at the bottom of the column) at regular time intervals and the composition of each sample determined via ICP-OES.

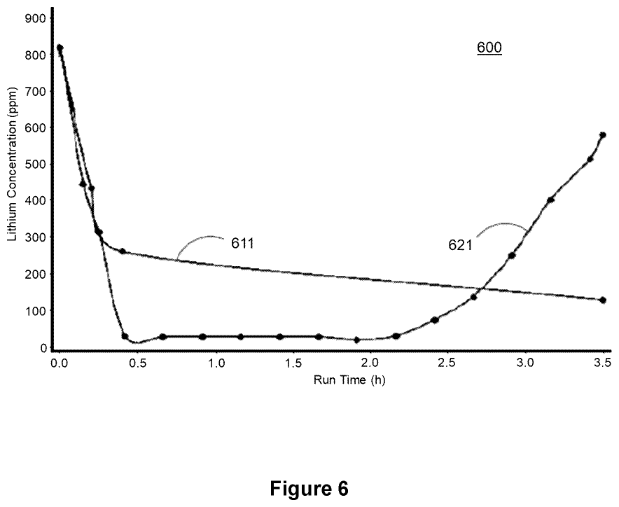

FIG. 6 depicts a plot 600 of lithium concentration as a function of sample time, providing a visual depiction of the capacity of the test composition. In FIG. 6, lithium concentration of the bulk solution is indicated with reference numeral 611 and lithium concentration at the outlet is indicated with reference numeral 621. This can be described as a steep decrease in the lithium concentration at the outlet relative to the initial brine concentration. The low lithium concentration extends for a time interval characteristic of a sorbent before beginning to rise again-thus taking the form of a “bath-tub”. As the sorbent nears saturation, the outlet Li concentration rises until reaching the initial Li concentration of the feed brine.

A more formal determination of the capacity was determined by the amount of adsorbed Li as calculated by Formula 4.

$$Absorbed Lihium = ( {[ Li ]}_{initial} - {[ Li ]}_{F i n a l} ) \times V o {l}_{B r i n e} \qquad Formula 4$$

Wherein:
   Absorbed Lithium=total lithium absorbed, in mg
   [Li]_{Initial}: initial lithium concentration, in mg/L
   [Li]_{Final}: initial lithium concentration, in mg/L
   Vol_{Brine}: volume of brine tested, in L

The capacity of the sorbent is then calculated by Formula 5:

$$Lithium capacity = \frac{Adsorbed Lithium}{{M}_{S o r b e n t}} \qquad Formula 5$$

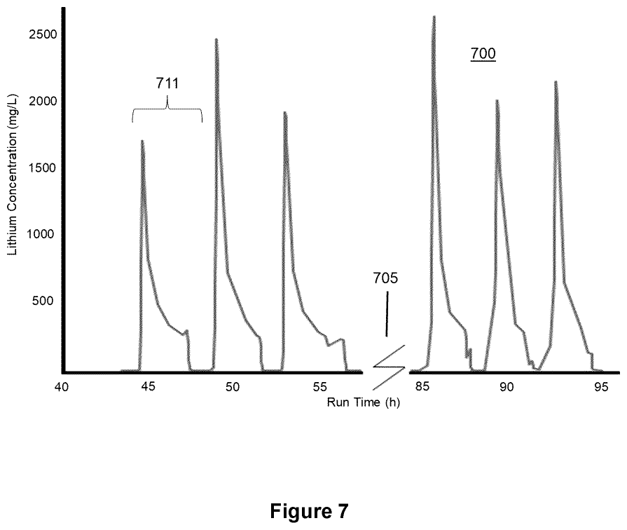

As an example of continuous usage, FIG. 7 displays an excerpt of process monitoring data 700 for a H²-LIAH composition of the present disclosure as deployed in an embodiment of an apparatus for recovering lithium from a lithium containing solution in accordance with the present disclosure and as deployed in a method for recovering lithium from a lithium containing solution in accordance with the present disclosure. For brevity, the x-axis is truncated by a caesura 705. The typical cycle 711 displays the lithium concentration variation first as brine is loaded into the system, and then as lithium is adsorbed onto the H²-LIAH loaded column. Column performance is maintained through successive cycles, such that chemical durability and/or physical durability may be evaluated. Samples were obtained from the outlet (at the bottom of the column) at regular time intervals and the composition of each sample determined via ICP-OES.

In the present embodiment, elutions were performed using a volume of eluent equivalent to the feed brine and at flux rates corresponding to 300 to 800 L/m₂/hour. Sampling was performed similarly to that in the adsorption stage. For sorbent evaluation, two to three adsorption/elution cycles were performed using the synthetic feed prior to evaluation using a real brine sample for comparison.

An aspect of the present disclosure relates to a sorbent for recovering lithium from a lithium containing solution, the sorbent comprising a LIAH composition having a crystallization-hydrate:lithium molar ratio of at least about 2.1:1.0. In the context of the present disclosure, a LIAH composition may include a single compound or a plurality of compounds. In an embodiment of the present disclosure, the crystallization-hydrate:lithium molar ratio of the LIAH composition may be between about 2.1:1.0 and about 4.3:1.0 In an embodiment of the present disclosure, the crystallization-hydrate:lithium molar ratio of the LIAH composition may be less than about between about 2.4:1.0 and about 2.9:1.0. In an embodiment of the present disclosure, the crystallization-hydrate:lithium molar ratio of the LIAH composition may be less than about 4.3:1.0 In an embodiment of the present disclosure, the crystallization-hydrate:lithium molar ratio of the LIAH composition may be less than about between about 2.9:1.0 and about 4.0:1.0. Those skilled in the art, having benefited from the teaching of the present disclosure will understand how to tailor manufacturing conditions to provide LIAH compositions within the noted ranges. For example, the following parameters may be controlled to induce higher crystallization-hydrate:lithium molar ratios (reference numerals related to the method of manufacturing steps described herein):
increasing the concentration of the hydroxide solution used in step (i) and/or step (iv);
increasing the pH of the reaction mixture above about 9.0 (for example to about 10.0 or about 11.0) in step (i);
1 reducing the pH of the reaction mixture below about 4.0 (for example to about 3.0 or about 2.0) in step (ii);
minimizing high-shear mixing during step (iii); and/or
reducing the reaction time for step (iii) and/or step (iv).

In an embodiment of the present disclosure, the crystallization-hydrate:lithium molar ratio of the LIAH composition may be determined from DSC, ICP-OES, TGA, or a combination thereof. Analysis of the H²-LIAH compositions of the present disclosure need not be limited to these analytical techniques. Those skilled in the art will appreciate that other characterization techniques may supplement, support, or replace one or more of the foregoing analyses without departing from the scope of the present disclosure. In the context of the present disclosure, analysis by DSC may require samples to be loaded into aluminum transfer crucibles prior to analysis. Each crucible may be capped, and each cap may be perforated with a sharp tip to allow for the evolution of gases throughout the experiment. During analysis, the samples may be treated to a constant rate of increasing temperature, from ambient to 450° C. Experimental data may be provided as enthalpic changes during heating. In the context of the present disclosure, samples for TGA may be loaded into aluminum transfer crucibles. During analysis the samples may be treated to a constant rate of increasing temperature, from ambient to 450° C. Experimental data may be provided as relative mass loss (%) during heating. In the context of the present disclosure, prior to elemental analysis by ICP-OES (or, alternatively, ICP-MS) samples may be digested with acid in plasticware and diluted for analysis with deionized water. In the context of the present disclosure, FTIR samples may be prepared by grinding materials to a powder, after which they may be mounted on an FTIR spectrometer equipped an ATR accessory. Spectra may be acquired over the range of 4000-400 cm-1. In the context of the present disclosure, samples to be analyzed by XRD may be delumped and mounted on X-ray transparent supports (e.g. single crystal silicon) and analyzed using Bragg-Brentano instrumental geometry. In an embodiment of the present disclosure, the LIAH composition may be characterized by 2θ reflectance peaks at approximately 11.5° 2θ, 23.1° 2θ, 35.0° 2θ, and 35.7° 2θ, or a combination thereof via XRD. Likewise, LIAH compositions of the present disclosure may be characterized by the absence of 2θ reflectance peaks at 18.2° 2θ, via XRD.

In an embodiment of the present disclosure, the LIAH composition may have an aluminum:lithium molar ratio of at least about 1.9:1.0. In an embodiment of the present disclosure, the LIAH composition may have an aluminum:lithium molar ratio of between about 2.0:1.0 and about 3.0:1.0. In an embodiment of the present disclosure, the LIAH composition has an aluminum:lithium molar ratio of between about 2.4:1.0 and about 2.6:1.0. This skilled in the art will appreciate that such elemental ratios may be determined by ICP or another suitable analytical technique.

In an embodiment of the present disclosure, the LIAH composition may be as described in Formula 1:

LiₐX·mAl(OH)₃·nH₂O_{cr} Formula 1
wherein:
   a is about 1;
   X is a monovalent anion (e.g. F⁻, Cl⁻, Br⁻, and/or I⁻);
   m is between about 1.9 and about 3.0;
   n is between about 2.4 and about 4.3; and
   H₂O_{cr} specifies crystallization-hydrate.

In an embodiment of the present disclosure, the LIAH composition may be a lithium-aluminum-layered-double-hydroxide composition.

In an embodiment of the present disclosure, the sorbent may further comprise a binding agent, an encapsulating agent, or a combination thereof. Suitable agents may be organic or inorganic and may include alginates, biochars, biopolymers, carbonaceous ores, clays, polyvinyl alcohols, methyacrylates, graphenes, metal organic frameworks, nanotubes, polyphenols, synthetic polymers, polysaccharides, silicates, combinations thereof, and the like.

In an embodiment of the present disclosure, the LIAH composition may have a lithium uptake capacity of at least about 8.0 mg/ml. In an embodiment of the present disclosure, the lithium uptake capacity of the LIAH composition may be at least about 9.0 mg/ml. In an embodiment of the present disclosure, the lithium uptake capacity of the LIAH composition may be between about 9.5 mg/ml and about 12.0 mg/ml. In an embodiment of the present disclosure, the LIAH composition may be processable to provide a particle size distribution in which at least about 40% of particles are between about 500 μm, and about 1,000 μm. In an embodiment of the present disclosure, the LIAH composition may be processable to provide a particle size distribution in which at least about 50% of particles are between about 500 μm, and about 1,000 μm. In an embodiment of the present disclosure, the LIAH composition may be processable to provide a particle size distribution in which at least about 55% of particles are between about 500 μm, and about 1,000 μm. Those skilled in the art, having benefited from the teaching of the present disclosure will understand how to tailor manufacturing conditions to provide LIAH compositions within the noted ranges. For example, the following parameters may be controlled to induce larger particle sizes (reference numerals related to the method of manufacturing steps described herein):
increasing the concentration of the hydroxide solution used in step (i) and/or step (iv);
increasing the pH of the reaction mixture above about 9.0 (for example to about 10.0 or about 11.0) in step (i);
reducing the pH of the reaction mixture below about 4.0 (for example to about 3.0 or about 2.0) in step (ii);
minimizing high-shear mixing during step (iii);
reducing the reaction time for step (iii) and/or step (iv);
at step (v), drying the gel-like material at a temperature of between about 85° C. and 120° C.;
at step (v), drying the gel-like material at a thickness of at least about 4 cm;
at step (v), drying the gel-like material for about between about 24 h and about 72 h; and/or
at step (v), drying the gel-like material to a mass reduction between about 30% and about 60%.

In an embodiment of the present disclosure, suspending the LIAH composition in deionized water may provide a solution having a pH of between about 7.0 and about 6.2. The H²-LIAH compositions of the present disclosure may retain relatively low concentrations of residual hydroxide ions. For example, suspending a H²-LIAH compositions of the present disclosure in deionized water may provide a solution having a pH of less than about 5, less than about 6, or between about 6.5 and about 7. This may be beneficial in that the formation of insoluble hydroxides may result from exposure to complex brines. Without being bound to any particular theory, complex brines may include relatively high concentrations of divalent ions such as Ca²⁺ and Mg²⁺, which may precipitate out of solutions containing relatively high concentrations of hydroxides, and this may manifest as an increase in pressure drop within the sorbent column which leads to lower operating flow rates and lower Lithium uptake performance. The H²-LIAH compositions of the present disclosure may attenuate this issue.

In an embodiment of the present disclosure, suspending the LIAH composition in deionized water may provide a turbidity value of less than 10 NTU. In an embodiment of the present disclosure, suspending the LIAH composition in deionized water may provide a turbidity value of less than 5 NTU. In an embodiment of the present disclosure, suspending the LIAH composition in deionized water may provide a turbidity value of between about 2.5 NTU and about 5 NTU. This may be beneficial for DLE sorbent process engineering in that it may correlate with improved structural integrity during process flow. In the context of the present disclosure, turbidity measurement may involve suspending a unit of material in deionized water and gently mixing to disperse. The suspension may be decanted out into a separate beaker and turbidity measurements may be conducted on the decanted solutions.

In an embodiment of the present disclosure, the LIAH composition may have a Mohs hardness of at least about 5.0. In an embodiment of the present disclosure, the Mohs hardness of the LIAH composition may be at least about 6.0. In an embodiment of the present disclosure, the Mohs hardness of the LIAH composition may be at least about 7.0. The hardness of the LIAH compositions of the present disclosure may be characterized via Mohs scale of mineral hardness, which is a qualitative ordinal scale, from 1 to 10, characterizing scratch resistance of various minerals through the ability of harder material to scratch softer material. In the context of the present disclosure, determining the hardness of a sample (prior to manual grinding and sieving) may involve scratching with items of increasing hardness (e.g., a fingernail, copper wire, a piece of glass and a stainless steel pick), and noting if the particle fractured or generated a significant amount of dust. The particle hardness may be determined using a bracketing method. For example, if a sample did not fracture with a fingernail but did with copper wire than that batch was noted to correspond to a Mohs hardness between 2 and 3. Without being bound to any particular theory, the high hardness of the compositions of the present disclosure may be a physical manifestation of a high degree of crystallinity, and this may underlie their performance as sorbents for DLE.

In an embodiment of the present disclosure, the LIAH composition may be robust with respect to degradation for at least about 500 column cycles. In an embodiment of the present disclosure, the LIAH composition is robust with respect to degradation for at least about 5,000 column cycles.

### Methods of Manufacturing H²-LIAH Compositions

In accordance with an embodiment of the present disclosure, a H²-LIAH composition was prepared as follows. Lithium chloride (0.961 kg) was dissolved into a solution of AlCl₃ (21.733 kg, 25-30%) and combined with an overhead stirrer, such that the of molar ratio Li:Al was about 1:2. With a mixing rate set to about 240 rpm, an aliquot of a NaOH solution (2.18 kg, 50%) was combined with an aliquot of the LiCl/AlCl₃ mixture. The pH of the reaction mixture was monitored as it was increased to greater than about 10, and the temperature of the reaction mixture increased to between about 90° C. and about 97° C. With continued mixing, a further aliquot of the LiCl/AlCl₃ solution was added slowly, and the reaction mixture was observed to thicken as the pH decreased to less than about 3. A gel-like material formed upon the total addition of LiCl/AlCl₃ solution. The mixing rate was decreased to about 100 rpm to reduce potential for material over shearing, and a further aliquot of the 50% NaOH solution was added until the pH of the gel-like material was between about 6.8 and 7.2. The reaction mixture was weighed, transferred to a drying tray, and placed in a drying oven where it was aged for about 5 h at about 95° C. The layering of the slurry was reduced below approximately 4 cm, to reduce the production of fines (e.g. particles sized less than about 250 μm) and to maintain a particle size range between about 250 μm to greater than about 2,000 μm. After this time, the solids formed a wet cake, which was remixed before continued drying to reduce its mass to 60% of its initial value. After cooling, the solids were desalted (e.g. to remove NaCl) by rinsing with deionized water under suction filtration until the rinse solution achieved a conductivity of less than about 15 ms/cm. The final gel was transferred back to the oven and dried at about 95° C. for between about 16 h and about 24 h to yield the H²-LIAH composition as a dried product. The H²-LIAH composition was sieved to obtain particle fractions having sizes ranging between about 250 μm to greater than about 2,000 μm, and the H²-LIAH composition was characterized as described herein.

In accordance with an embodiment of the present disclosure, a H²-LIAH composition was prepared as follows. Lithium chloride (0.961 kg) was blended with a solution of AlCl₃ (17.045 kg, 28-30%) such that the molar ratio of Li:Al was about 1:2, respectively. The LiCl/AlCl₃ mixture was mixed at 200 rpm to ensure full dissolution of the salt. Separately, NaOH pellets (110 g) were dissolved in deionized water (380 mL) to form a 7.2 M (or approx. 29% wt/vol) hydroxide solution. The LiCl/AlCl₃ mixture as added to the hydroxide solution slowly (at a rate of 2 L/min) with mixing via an overhead mixer, and the pH of the reaction mixture was monitored. The pH of the reaction mixture decreased from greater than about 12 to less than about 3 before the addition of the LiCl/AlCl₃ mixture was complete. As the reaction mixture approached the minima of this pH transition, a significant increase in solution viscosity occurred, and the mixing rate was increased enough to retain a vortex in a gel-like material while avoiding potential over shearing. Mixing was continued for about 10 min after the addition of the LiCl/AlCl₃ mixture. The mixing rate was then reduced to 100 rpm, and a further aliquot of hydroxide solution was added to adjust the pH of the gel-like material to about 7.0. The gel-like material remained without a notable decrease in the viscosity of the reaction mixture. The reaction mixture was transferred to a collection of drying trays and weighed, each tray loaded to a minimum thickness of about 4 cm to reduce the overproduction of fines (e.g. <250 μm) and maintain a particle size range between about 250 μm to greater than about 2,000 μm. The loaded drying trays were placed in a drying oven, where the reaction mixture was aged for 5 h at about 95° C. After this time, the solids formed a wet cake, which was remixed before continued drying to reduce its mass to about 70% of its initial value. After cooling, the solids were desalted (so as to remove NaCl) by rinsing with deionized water under suction filtration until the rinse solution achieved a conductivity of less than about 15 ms/cm. The final gel-like material was transferred back to the oven and dried at 95° C. for 24 hours to provide yield the H²-LIAH composition as a dried product. The H²-LIAH composition was sieved to obtain particle fractions having sizes ranging between about 250 μm to greater than about 2,000 μm, and the H²-LIAH composition was characterized as described herein.

In an embodiment of the present disclosure, as the reaction mixture approaches the minima of the pH transition associated with the addition of the LiCl/AlCl₃ mixture, and the gel-like material forms, the mixing time may be selected to balance: (i) increasing homogeneity, and thus modulate the strength of the gel; with (ii) reducing formation of carbonates generated from long term atmospheric exposure; and/or (iii) reducing impurity formation.

An aspect of the present disclosure relates to a method of manufacturing a LIAH composition, the method comprising:
(i) combining an initial aliquot of a hydroxide solution with an initial aliquot of a solution comprising a lithium halide and an aluminum halide to form a reaction mixture in which the hydroxide solution is in excess such that the pH of the reaction mixture is at least about 9.0;
(ii) adding a further aliquot of the solution comprising the lithium halide and the aluminum halide to the reaction mixture such that the pH of the reaction mixture is reduced to less than about 4.0;
(iii) allowing the reaction mixture to form a gel-like material; and
(iv) adding an additional aliquot of the hydroxide solution to the reaction mixture to increase the pH of the reaction mixture to between about 6.5 and about 7.5.

In an embodiment of the present disclosure, in step (i), the initial aliquot of the hydroxide solution is added to the initial aliquot of the solution comprising the lithium halide and the aluminum halide.

In an embodiment of the present disclosure, in step (i), the initial aliquot of the solution comprising the lithium halide and the aluminum halide is added to the initial aliquot of the hydroxide solution.

In an embodiment of the present disclosure, the initial aliquot of the solution comprising the lithium halide and the aluminum halide and the further aliquot of the solution comprising the lithium halide and the aluminum halide are derived from the same stock solution.

In an embodiment of the present disclosure, the initial aliquot of the hydroxide solution and the further aliquot of the hydroxide solution are derived from the same stock solution.

In an embodiment of the present disclosure, the solution comprising the lithium halide and the aluminum halide has a lithium:aluminum molar ratio of between about 1.0:2.0 and about 1.0:3.0.

In an embodiment of the present disclosure, the hydroxide solution has a concentration of between about 6.5 M and about 8.0 M.

In an embodiment of the present disclosure, the lithium halide is lithium fluoride, lithium chloride, lithium bromide, lithium iodide, or a combination thereof.

In an embodiment of the present disclosure, the lithium halide is lithium chloride.

In an embodiment of the present disclosure, the aluminum halide is aluminum trifluoride, aluminum trichloride, aluminum tribromide, aluminum triiodide, or a combination thereof.

In an embodiment of the present disclosure, the aluminum halide is aluminum trichloride.

In an embodiment of the present disclosure, the hydroxide solution is a sodium hydroxide solution, a potassium hydroxide solution, a calcium hydroxide solution, a magnesium hydroxide solution, or a combination thereof.

In an embodiment of the present disclosure, the hydroxide solution is a sodium hydroxide solution.

In an embodiment of the present disclosure, the rate of addition of hydroxide solution is between about 9.5 mL/min and about 10.5 L/min.

In an embodiment of the present disclosure, in step (iii), step (iv), or a combination thereof, the reaction mixture is agitated to modulate the viscosity of the gel-like material.

In an embodiment of the present disclosure, in step (iii), step (iv), or a combination thereof, the temperature of the reaction mixture is controlled to modulate the viscosity of the gel-like material.

In an embodiment of the present disclosure, in step (iii), step (iv), or a combination thereof, the pressure of the reaction mixture is controlled to modulate the viscosity of the gel-like material.

In an embodiment of the present disclosure, in step (iii), step (iv), or a combination thereof, the reaction time is controlled to modulate the viscosity of the gel-like material.

In an embodiment of the present disclosure, in step (ii), step (iv), or a combination thereof, the rate of addition is controlled to modulate the viscosity of the gel-like material.

In an embodiment of the present disclosure, the method further comprises: (v) curing the gel-like material into the LIAH composition.

In an embodiment of the present disclosure, step (v) comprises drying at a temperature between about 85° C. and about 95° C.

In an embodiment of the present disclosure, step (v) comprises drying for between about 24 h and about 75 h.

In an embodiment of the present disclosure, comprises drying at a pressure between about 76 mmHg and about 760 mmHg.

In an embodiment of the present disclosure, step (v) comprises aging, rinsing, drying, sieving, or a combination thereof.

An aspect of the present disclosure relates to a sorbent manufactured by a method as defined herein.

The mixing rate, increased reactant concentration, reagent addition order relative to stoichiometric control and change in viscosity corresponded to an increase in gel strength.

An increase in gel strength is correlated to a higher amount of crystallization-hydrates.

In contrast to the protocols described above that utilize a pH-inversion protocol, conventional methods of LIAH manufacturing using: (i) addition of a LiCl/AlCl₃ solution to a hydroxide solution without dropping substantially below a pH of about 6.5; or (ii) no pH control during the addition of a stoichiometric amount of a LiCl/AlCl₃ solution to a hydroxide) solution such the final pH of the mixture was greater than 6.5 did not result in a gel-like material and were not furnished into a H²-LIAH composition as described herein.

Apparatus and Methods for Recovering Lithium from Brine Using H²-LIAH Compositions

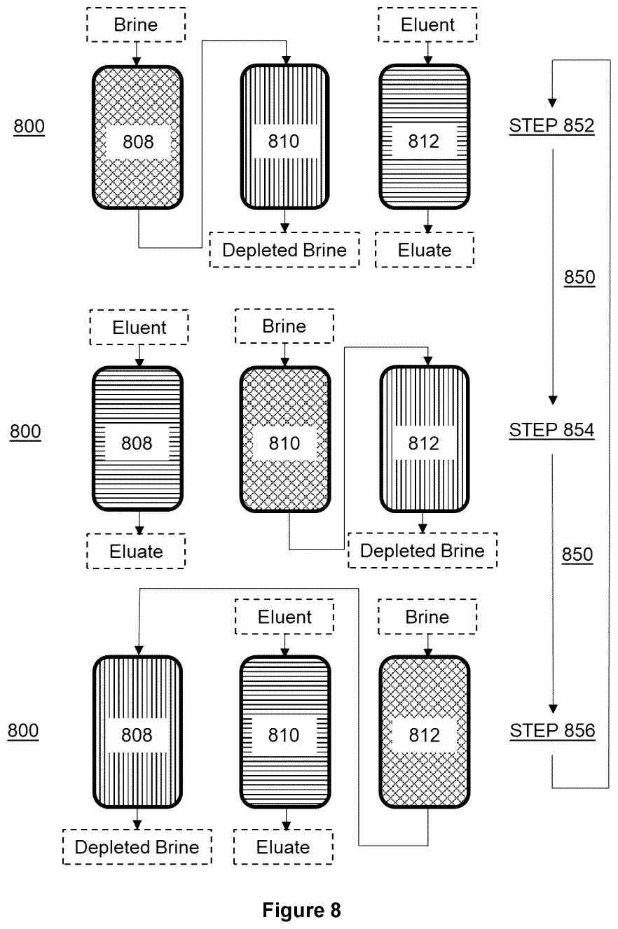

FIG. 8 shows an apparatus 800 for recovering lithium from a lithium containing solution in accordance with an embodiment of the present disclosure. FIG. 8 also shows a method 850 for recovering lithium from a lithium containing solution in accordance with an embodiment of the present disclosure. Apparatus 800 is configured to execute method 850 using a lead, guard, elution column configuration. The lead column is indicated by cross hatching, the guard column is indicated by horizontal hatching, and the elution column is indicated by vertical hatching. During operation, these columns are rotated through an extraction cycle. This process is depicted in FIG. 8, where apparatus 800 comprises columns 808, 810, and 812, which process brines according to steps 852, 854, and 856 as follows.

At step 852, column 808 is absorbing lithium while column 810 acts as a guard column to collect any residual lithium before depleted brine is discharged as a raffinate which may be recycled for further lithium extraction, further treated, stored, or disposed of. Also at step 802, an eluent is flowed through column 812 to desorb lithium absorbed during a previous cycle. This provides a lithium-enhanced eluate, which may be passed to a water recovery technology.

At step 854, column 810 is reconfigured from guard column to lead column. Column 810 receives brine and absorbs lithium therefrom. Also at step 854, column 812 is reconfigured from elution column to guard column, and it absorbs residual lithium. Also at step 854, column 808 is reconfigured from lead column to elution column, and it desorbs lithium retained from step 852.

At step 856, column 812 is reconfigured from guard column to lead column. Column 812 receives brine and absorbs lithium therefrom. Also at step 856, column 808 is reconfigured from elution column to guard column, and it absorbs residual lithium. Also at step 856, column 810 is reconfigured from lead column to elution column, and it desorbs lithium retained from step 854.

Steps 852, 854, and 856 may be cycled by adjusting a valve manifold (or an alternative means for fluid control) to direct flows of brine, eluent, and the like.

As will be appreciated by those skilled in the art, apparatus 800 is one of many configurations that may be suitable for recovering lithium in the context of the present disclosure (likewise for method 850), as apparatus and methods for recovering lithium from lithium containing solutions are generally known to those skilled in the art. PCT patent publication: WO WO2020/257937 A1, the contents of which are incorporated herein by reference, may disclose apparatus and methods for recovering lithium from brine that are suitable in the context of the present disclosure. Those skilled in the art will appreciate the science and engineering fundamentals (e.g. equilibrium and mass transfer considerations) associated with using sorbents in such apparatus and/or methods, as evidenced by: Gableman, A., “Absorption Basics: Part 1,” Chemical Engineering Progress, 113 (7), pp 48-53 (July 2017), the contents of which are herein incorporated by reference. For example, apparatus for lithium recovery in accordance with the present disclosure may be configured as sequential flow systems (also referred to as a “daisy chain” flow systems) configured in parallel, in series or in combinations of parallel and series, flowing either in up flow or down flow modes. Likewise, apparatus for lithium recovery in accordance with the present disclosure may employ countercurrent extraction. In countercurrent extraction, the eluent is pumped countercurrent to sorbent advance for example by way of an indexed multi-port valve system and/or a carousel of sorbent containers. Apparatus for lithium recovery in accordance with the present disclosure may be configured to operate under a variety of temperature and pressure conditions. For example, apparatus for lithium recovery in accordance with the present disclosure may operate at temperatures less than about 60° C., between about 60° C. and about 100° C., and/or greater than about 100° C.

In the context of the present disclosure, a lithium containing solution may be a brine, such as one recovered from naturally occurring continental brine deposits. A lithium-containing solution may also be from fluid brine suspensions produced from hydraulic mining operations of geological formations, and/or from brines and wastewater produced from oil and gas production activities. The constitutions of lithium containing solutions suitable for use with the sorbents, apparatus, and/or methods of the present disclosure may vary widely. For example, lithium containing solutions having total dissolved solids (TDS) between about 50 ppm and about 5,000 ppm, between about 5,000 ppm and about 10,000 ppm, between about 10,000 ppm to about 100,000 ppm or between about 100,000 to about 250,000 ppm may be suitable. With respect to cation loading, suitable lithium containing solutions may comprise varying concentrations of lithium, sodium, potassium, calcium, magnesium, or combinations thereof. For example, a lithium containing solution may comprise about 5000 ppm K⁺, about 1000 ppm Na⁺, about 500 ppm Li⁺, and about 50 ppm Ca²+.

In the context of the present disclosure, the term “brine” may refer to a natural brine, a synthetic brine, or a combination thereof. In the context of the present disclosure, the term “ion” is defined as a metal ion of any valency including, but not limited to, lithium, potassium, calcium, magnesium, manganese, iron, zinc, cobalt, nickel, titanium, aluminum, tin, gallium, silver, gold, copper, cadmium, or a combination thereof. In the context of the present disclosure, the term “lithium” is used broadly to encompass lithium ions in solution, absorbed to a surface, and in chemical compositions such as lithium chloride, lithium carbonate, and lithium hydroxide. Those skilled in the art will recognize that lithium ions may take a variety of forms, all of which fall within the scope of the present disclosure. For example, lithium ions may be hydrated, participating in coordinated ion pairs, retained in interstitial sites, suspended in colloid forms, and the like.

An aspect of the present disclosure relates to an apparatus for recovering lithium from a lithium containing solution, the apparatus comprising: a container having an inlet, an outlet, and a contiguous flow path therebetween; and a sorbent comprising a H²-LIAH composition having a crystallization-hydrate:lithium molar ratio of at least 2.1:1.0.

An aspect of the present disclosure relates to an apparatus for recovering lithium from a lithium containing solution, the apparatus comprising: a container having an inlet, an outlet, and a contiguous flow path therebetween; and a sorbent as defined herein.

An aspect of the present disclosure relates to a method for recovering lithium from a lithium containing solution, the method comprising: contacting the lithium containing solution with a sorbent composition to extract lithium from the lithium containing solution; and eluting lithium from the sorbent composition to form a lithium eluate solution, wherein the sorbent composition comprises a LIAH composition having a crystallization-hydrate:lithium molar ratio of at least 2.1:1.0.

An aspect of the present disclosure relates to a method for recovering lithium from a lithium containing solution, the method comprising: contacting the lithium containing solution with a sorbent composition to extract lithium from the lithium containing solution; and eluting lithium from the sorbent composition to form a lithium eluate solution, wherein the sorbent composition comprises a LIAH composition as defined herein.

A method for recovering lithium from a lithium containing solution, the method comprising: contacting the lithium containing solution with a sorbent comprising a LIAH composition as defined herein to extract lithium from the lithium containing solution; and eluting lithium from the sorbent to form a lithium eluate solution.

Although the present invention has been described and illustrated with respect to preferred embodiments and preferred uses thereof, it is not to be so limited since modifications and changes can be made therein which are within the full, intended scope of the invention as understood by those skilled in the art.

While particular aspects of the subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

Note that the same features of the present invention may be represented by more than one numeral in the specification and drawings. For example, a feature denoted by numeral 100 in FIG. 1 may be denoted by 200 in FIG. 2, 300 in FIG. 3, etc. Features denoted with the same numeral in different figures are the equivalent and/or same feature but in different embodiments and should be considered equivalent and/or the same for the purposes of interpreting the specification and/or drawings.

It will be understood by those skilled in the art that, in general, terms used herein, and especially in the appended claims are generally intended as “open” terms (e.g., the term “comprising” should be interpreted as “including but not limited to”,” the term “having” should be interpreted as “having at least,” the term “has” should be interpreted as “has at least,” etc.).

It will be further understood by those skilled in the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

It will be further understood by those skilled in the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise.

Throughout this application, the terms “in an embodiment”, “in one embodiment”, “in an embodiment”, “in several embodiments”, “in at least one embodiment”, “in various embodiments,” and the like, may be used. Each of these terms, and all such similar terms should be construed as “in at least one embodiment, and possibly but not necessarily all embodiments,” unless explicitly stated otherwise. Specifically, unless explicitly stated otherwise, the intent of phrases like these is to provide non-exclusive and non-limiting examples of implementations of the subject matter.

The term of degree “substantially”, as used herein means a reasonable amount of deviation of the modified term such that the end result is not significantly changed. The term “substantially” should be construed as including a deviation of ±5% of the modified term if this deviation would not negate the meaning of the term it modifies. The terms of degree “about” and “approximately should be construed as including a deviation of ±20%. For example, when the terms “approximately” or “about” are used in relation to a numerical value, they modify it above and below by a 20% variation compared to the nominal value. This term can also take into account, for example, the experimental error of a measuring device or rounding. Other terms of degrees should be construed as including a deviation of ±5% of the modified term.

When a range of values is mentioned herein, the lower and upper limits of the range are, unless otherwise indicated, always included in the definition. When a range of values is mentioned herein, then all intermediate ranges and subranges, as well as individual values included in the ranges, are intended to be included.

The mere statement that one, some, or may embodiments include one or more things or have one or more features, does not imply that all embodiments include one or more things or have one or more features, but also does not imply that such embodiments must exist. It is a mere indicator of an example and should not be interpreted otherwise, unless explicitly stated as such.

Those skilled in the art will appreciate that the foregoing specific exemplary compositions, apparatus, and/or methods are representative of more general processes and/or devices and/or technologies taught elsewhere herein, such as in the appended claims filed and/or elsewhere in the present disclosure.

1. A sorbent for recovering lithium from a lithium containing solution, the sorbent comprising a high-hydration lithium-incorporated-aluminum-hydroxide (H²-LIAH) composition having a crystallization-hydrate:lithium ratio of at least about 2.1:1.0.

2. The sorbent of claim 1, wherein the crystallization-hydrate:lithium ratio of the H²-LIAH composition is between about 2.1:1.0 and about 4.3:1.0.

3. The sorbent of claim 1 or 2, where in the crystallization-hydrate:lithium ratio of the H²-LIAH composition is between 2.1:1.0 and about 2.9:1.0.

4. The sorbent of claim 1 or 2, where in the crystallization-hydrate:lithium ratio of the H²-LIAH composition is between 2.9:1.0 and about 4.0:1.0.

5. The sorbent of any one of claims 1 to 4, wherein the crystallization-hydrate:lithium ratio of the H²-LIAH composition is determined from differential scanning calorimetry, inductively coupled plasma optical emission spectrometry, thermogravimetric analysis, or a combination thereof.

6. The sorbent of any one of claims 1 to 5, wherein the H²-LIAH composition has an x-ray diffraction pattern having 2θ reflectance peaks at 11.5° 2θ, 23.1° 2θ, 35.0° 2θ, 35.7° 2θ, or a combination thereof.

7. The sorbent of any one of claims 1 to 6, wherein the H²-LIAH composition has an aluminum:lithium ratio of at least about 1.9:1.0.

8. The sorbent of claim 7, wherein the aluminum:lithium ratio of the H²-LIAH composition is between about 2.0:1.0 and about 3.0:1.0.

9. The sorbent of claim 8, wherein the aluminum:lithium ratio of the H²-LIAH composition is between about 2.4:1.0 and about 2.6:1.0.

10. The sorbent of any one of claims 1 to 9, wherein the H²-LIAH composition is as described in Formula 1:
LiₐX·mAl(OH)₃·nH₂O_{cr} Formula 1
wherein:
In which:
a is about 1;
X is a monovalent anion;
m is between about 1.9 and about 3.0;
n is between about 2.4 and about 4.3; and
H₂O_{cr} specifies crystallization-hydrate.

11. The sorbent of any one of claims 1 to 10, wherein the H²-LIAH composition is a lithium-aluminum-layered-double-hydroxide composition.

12. The sorbent of any one of claims 1 to 11, further comprising a binding agent an encapsulating agent, or a combination thereof.

13. The sorbent of any one of claims 1 to 12, wherein the H²-LIAH composition has a lithium uptake capacity of at least about 8.0 mg/mL.

14. The sorbent of claim 13, wherein the lithium-uptake capacity of the H²-LIAH composition is at least about 9.0 mg/mL.

15. The sorbent of claim 14, wherein the lithium uptake capacity of the H²-LIAH composition is between about 9.5 mg/ml and about 12.0 mg/mL.

16. The sorbent of any one of claims 1 to 15, wherein the H²-LIAH composition is processable to provide a particle size distribution in which at least about 40% of particles are between about 500 μm, and about 1,000 μm.

17. The sorbent of any one of claims 1 to 15, wherein the H²-LIAH composition is processable to provide a particle size distribution in which at least about 50% of particles are between about 500 μm, and about 1,000 μm.

18. The sorbent of any one of claims 1 to 15, wherein the H²-LIAH composition is processable to provide a particle size distribution in which at least about 55% of particles are between about 500 μm, and about 1,000 μm.

19. The sorbent of any one of claims 1 to 18, wherein suspending the H²-LIAH composition in deionized water provides a solution having a pH of between about 7.0 and about 6.2.

20. The sorbent of any one of claims 1 to 19, wherein suspending the H²-LIAH composition in deionized water provides a turbidity value of less than 10 NTU.

21. The sorbent of any one of claims 1 to 19, wherein suspending the H²-LIAH composition in deionized water provides a turbidity value of less than 5 NTU.

22. The sorbent of any one of claims 1 to 19, wherein suspending the H²-LIAH composition in deionized water provides a turbidity value of between about 2 NTU and about 5 NTU.

23. The sorbent of any one of claims 1 to 22, wherein the H²-LIAH composition has a Mohs hardness of at least about 5.0.

24. The sorbent of claim 23, wherein the Mohs hardness of the H²-LIAH composition is at least about 6.0.

25. The sorbent of claim 24, wherein the Mohs hardness of the H²-LIAH composition is at least about 7.0.

26. The sorbent of any one of claims 1 to 25, wherein the H²-LIAH composition is physically durable under operating conditions for at least about 500 cycles.

27. The sorbent of any one of claims 1 to 26, wherein the H²-LIAH composition is physically durable under operating conditions for at least about 5,000 cycles.

28. The sorbent of any one of claims 1 to 27, wherein the lithium-incorporated-aluminum-hydroxide composition is chemically durable under operating conditions for at least about 500 cycles.

29. The sorbent of any one of claims 1 to 28, wherein the lithium-incorporated-aluminum-hydroxide composition is chemically durable under operating conditions for at least about 5,000 cycles.

30. A method of manufacturing a lithium-incorporated-aluminum-hydroxide composition, the method comprising:
(i) contacting an initial aliquot of a hydroxide solution with an initial aliquot of a solution comprising a lithium halide and an aluminum halide to form a reaction mixture in which the hydroxide solution is in excess and the pH of the reaction mixture is at least about 9.0;
(ii) adding a further aliquot of a solution comprising a lithium halide and an aluminum halide to the reaction mixture such that the pH of the reaction mixture is reduced to less than about 4.0;
(iii) allowing the reaction mixture to form a gel-like material; and
(iv) adding an additional aliquot of the hydroxide solution to the reaction mixture to increase the pH of the reaction mixture to between about 6.5 and about 7.5.

31. The method of claim 30, wherein in step (i), the initial aliquot of the hydroxide solution is added to the initial aliquot of the solution comprising the lithium halide and the aluminum halide.

32. The method of claim 30, wherein in step (i) the initial aliquot of the solution comprising the lithium halide and the aluminum halide is added to the initial aliquot of the hydroxide solution.

33. The method of any one of claims 30 to 32, wherein the initial aliquot of the solution comprising the lithium halide and the aluminum halide and the further aliquot of the solution comprising the lithium halide and the aluminum halide are derived from the same stock solution.

34. The method of any one of claims 30 to 33, wherein the initial aliquot of the hydroxide solution and the further aliquot of the hydroxide solution are derived from the same stock solution.

35. The method of any one of claims 30 to 34, wherein the solution comprising the lithium halide and the aluminum halide has an aluminum:lithium molar ratio of at least about 1.9:1.0.

36. The method of any one of claims 30 to 35, wherein the hydroxide solution has a concentration of between about 6.5 M and about 8.0 M.

37. The method of any one of claims 30 to 36, wherein the lithium halide is lithium chloride.

38. The method of any one of claims 30 to 37, wherein the aluminum halide is aluminum trichloride.

39. The method of any one of claims 30 to 38, wherein the hydroxide solution is a sodium hydroxide solution.

40. The method of any one of claims 30 to 39, wherein in step (ii), the rate of addition of the hydroxide solution is between about 9.8 L/min and about 10.8 L/min.

41. The method of any one of claims 30 to 40, wherein in step (iii), step (iv), or a combination thereof, the reaction mixture is agitated to modulate the viscosity of the gel-like material.

42. The method of any one of claims 30 to 41, wherein in step (iii), step (iv), or a combination thereof, the temperature of the reaction mixture is controlled to modulate the viscosity of the gel-like material.

43. The method of any one of claims 30 to 42, wherein in step (iii), step (iv), or a combination thereof, the pressure of the reaction mixture is controlled to modulate the viscosity of the gel-like material.

44. The method of any one of claims 30 to 42, wherein in step (iii), step (iv), or a combination thereof, the reaction time is controlled to modulate the viscosity of the gel-like material.

45. The method of any one of claims 30 to 44, wherein in step (ii), step (iv), or a combination thereof, the rate of addition is controlled to modulate the viscosity of the gel-like material.

46. The method of any one of claims 30 to 45, further comprising: (v) curing the gel-like material into the H²-LIAH composition.

47. The method of claim 46, wherein step (v) comprises drying at a temperature between about 85° C. and about 105° C.

48. The method of claim 46 or 47, wherein step (v) comprises drying for between about 24 h and about 75 h.

49. The method of any one of claims 46 to 48, wherein step (v) comprises drying at a pressure between about 76 mmHg and about 760 mmHg.

50. The method of any one of claims 46 to 49, wherein step (v) comprises rinsing, drying, sieving, or a combination thereof.

51. A high-hydration lithium-incorporated-aluminum-hydroxide composition manufactured by a method as defined in any one of claims 30 to 50.

52. An apparatus for recovering lithium from a lithium containing solution, the apparatus comprising:
a container having an inlet, an outlet, and a flow path therebetween; and
a sorbent in the container, the sorbent comprising a high-hydration lithium-incorporated-aluminum-hydroxide composition having a crystallization-hydrate:lithium molar ratio of between about 2.1:1.0 and about 4.3:1.0.

53. An apparatus for recovering lithium from a lithium containing solution, the apparatus comprising:
a container having an inlet, an outlet, and a flow path therebetween; and
a sorbent in the container, wherein the sorbent is as defined in any one of claims 1 to 29.

54. A method for recovering lithium from a lithium containing solution, the method comprising:
contacting the lithium containing solution with a sorbent to extract lithium from the lithium containing solution; and
eluting lithium from the sorbent to form a lithium eluate solution,
wherein the sorbent comprises a high-hydration lithium-incorporated-aluminum-hydroxide composition having a crystallization-hydrate:lithium molar ratio of at between about 2.1:1.0 and 4.3:1.0.

55. A method for recovering lithium from a lithium containing solution, the method comprising:
contacting the lithium-containing solution with a sorbent as defined in any one of claims 1 to 29 to extract lithium from the lithium containing solution; and
eluting lithium from the sorbent to form a lithium eluate solution.
